(19) United States
(12) Patent Application Publication
(10) Pub. No.: US 2009/0170994 A1
(43) Pub. Date: Jul. 2, 2009

(54) Compositions Comprising High Surface Area Ground Calcium Carbonate

(76) Inventors: David McConnell, Childersburg, AL (US); David Taylor, Tennille, GA (US); Edward Sare, Macon, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/720,617

(22) PCT Filed: Dec. 1, 2005
(86) PCT No.: PCT/US05/43084

§ 371 Date: Dec. 2, 2007

Related U.S. Application Data
(60) Provisional application No. 60/632,715, filed on Dec. 3, 2004.
(60) Provisional application No. 60/666,174, filed on May 13, 2005.

(51) Int. Cl. C08K 3/26; B32B 5/16; C08K 3/30

(52) U.S. Cl. 524/423; 428/402; 524/425

(57) ABSTRACT

Disclosed herein is are compositions comprising ground calcium carbonate having a mean particle size (d₅₀) having a BET surface area greater than commercially available compositions having a comparable mean particle size. Viscous nonaqucous compositions and low viscosity aqueous composition comprising such ground calcium carbonate compositions are also described herein. Also disclosed are methods of grinding calcium carbonate such that the product calcium carbonate has a large mean particle size as well as a large surface area.

This application claims priority to U.S. Provisional Patent Application No. 60/632,715, filed Dec. 3, 2004, and U.S. Provisional Patent Application No. 60/666,174, filed May 13, 2005.

Disclosed herein are compositions comprising ground calcium carbonate and viscous aqueous suspensions comprising ground calcium carbonate, and methods for preparing such compositions and suspensions. Also disclosed are products comprising the ground calcium carbonate disclosed herein.

Filled polymer products have become increasingly useful in a variety of applications, including household, electrical, construction, and office equipment products. Examples of such products include adhesives, caulks, sealants, rubbers, and plastics. Such filled polymer products typically comprise a mixture of an organic or petroleum based resin and an inorganic particulate filler. The filler is generally useful to reduce the volume of resin needed to produce the product, and often to improve processing and the product physical properties. This can result in substantial cost savings since the filler typically is considerably less expensive per unit volume than the replaced resin. For example, it is known to use relatively inexpensive ground calcium carbonate (GCC) as a filler for relatively expensive plastics, polymers, and latexes.

The properties of the ground calcium carbonate, such as particle size and particle size distribution, can affect the features of the resulting products. These properties may be controlled by varying the manner in which the calcium carbonate is ground. Grinding can be achieved by various conventional grinding techniques, such as jaw crushing, roller milling, hammer milling, and ball milling. Because of the continued demand for products containing ground calcium carbonate, including the previously mentioned filled products, there remains a need to develop ground calcium carbonate having new and desired properties.

The surface area of a particulate material such as calcium carbonate can have effects on its usefulness in a number of applications by affecting properties such as viscosity and/or resin demand. This can affect the usefulness of the calcium carbonate in applications such as use as a carrier, and use in paints, plastics, and or other polymers. The surface area of a collection of particles is typically inversely proportional to the particle size, e.g., surface area increases as the size of the particulate material decreases. However, for some applications, it would be beneficial to have a particulate material that has a surface area higher than would be expected for a conventional calcium carbonate having a given particle size.

There is disclosed herein a calcium carbonate having a large mean particle size as well as a relatively large surface area. Accordingly, one embodiment of the present disclosure relates to a ground calcium carbonate having a mean particle size (d₅₀) of at least about 1.0 μm, and a BET surface area of at least about 5.0 m²/g. In another embodiment, the present disclosure may relate to a ground calcium carbonate having a mean particle size (d₅₀) of at least about 2.3 μm, and a BET surface area of at least about 4.0 m²/g.

There is also disclosed a method of grinding calcium carbonate comprising autogenously grinding calcium carbonate feed to produce a ground calcium carbonate meeting the above-described parameters.

Additionally, there is disclosed products containing the above-described calcium carbonate compositions, such as adhesives, caulks, sealants, and filled polymers.

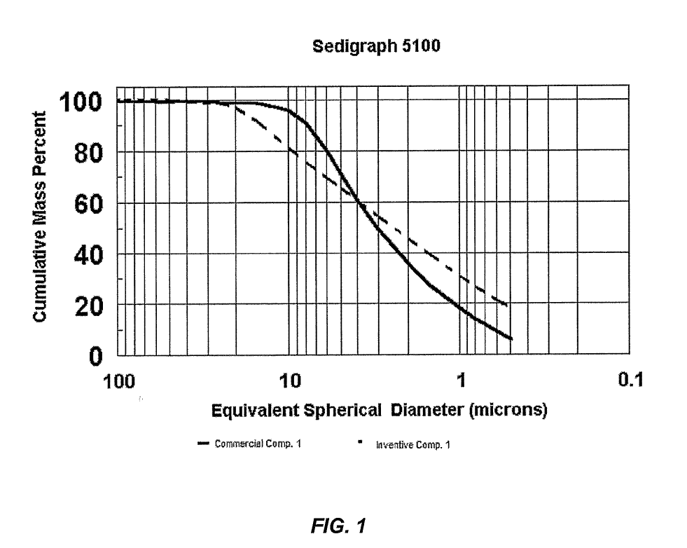

FIG. 1 is a plot of cumulative mass percent (y-axis) versus equivalent spherical diameter (μm, x-axis) for a commercially available 3 μm d₅₀ composition before and after grinding according to the present disclosure.

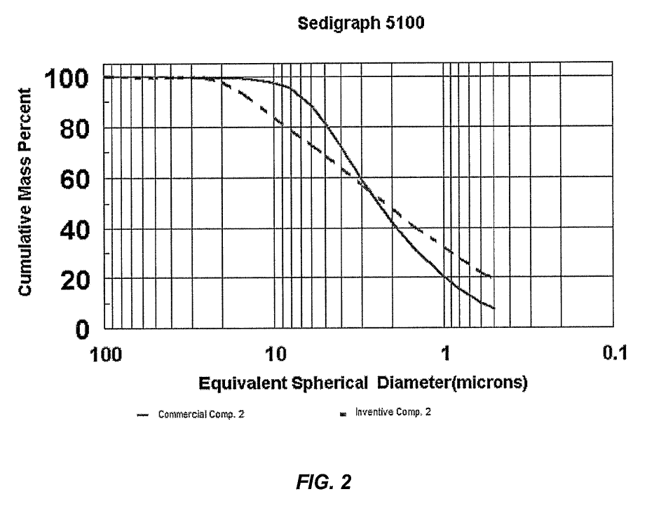

FIG. 2 is a plot of cumulative mass percent (y-axis) versus equivalent spherical diameter (μm, x-axis) for a commercially available 2.5 μm d₅₀ composition before and after grinding according to the present disclosure.

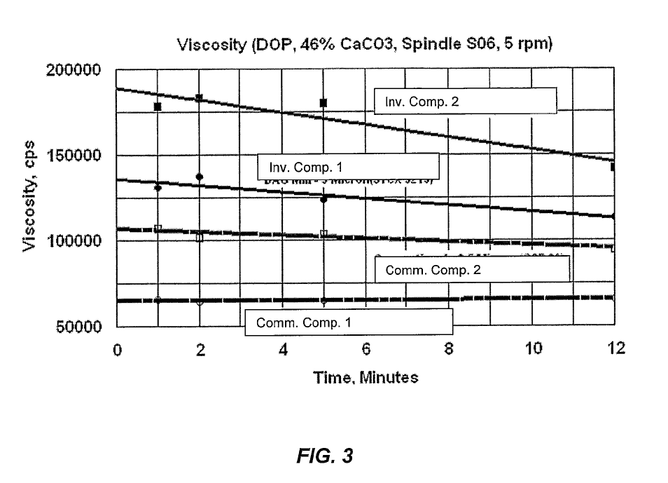

FIG. 3 is a plot of viscosity versus time for conventional products and products made according to the present disclosure.

One embodiment provides a ground calcium carbonate having a mean particle size (d₅₀) of at least about 1.0 μm, and a BET surface area of at least about 5.0 m²/g. In another embodiment, there is provided a ground calcium carbonate having a mean particle size (d₅₀) of at least about 2.3 μm, and a BET surface area of at least about 4.0 m²/g. In other embodiments, the ground calcium carbonate can have larger particle sizes, such as a d₅₀ of at least about 1.5 μm, such as a d₅₀ of at least about 2.0 μm, at least about 2.5 μm, at least about 2.6 μm, at least about 2.7 μm, at least about 2.8 μm, at least about 2.9 μm, or at least about 3.0 μm.

In another embodiment, there is provided a ground calcium carbonate having a mean particle size (d₅₀) of at least about 2.3 μm, and a BET surface area of at least about 4.0 m²/g. In other embodiments, the ground calcium carbonate can have larger particle sizes, such as a d₅₀ of at least about 2.5 μm, at least about 2.6 μm, at least about 2.7 μm, at least about 2.8 μm, at least about 2.9 μm, or at least about 3.0 μm.

The ground calcium carbonate may also have a d₅₀ of no more than about 5.0 μm or no more than about 4.0 μm, such as a d₅₀ ranging from about 2.3 μm to about 5.0 μm, a d₅₀ ranging from about 2.5 μm to about 5.0 μm, a d₅₀ ranging from about 2.3 μm to about 4.0 μm, or a d₅₀ ranging from about 2.5 μm to about 4.0 μm.

In one embodiment, the ground calcium carbonate can have larger BET surface areas, such as a BET surface area of at least about 4.0 m²/g, a BET surface area of at least about 4.5 m²/g, or a BET surface area of at least about 5.0 m²/g.

Another embodiment provides a ground calcium carbonate having a mean particle size (d₅₀) of at least about 10 μm, and a BET surface area of at least about 2.0 m²/g, such as greater than about 2.5 m²/g, greater than about 3.0 m²/g, greater than 3.5 m²/g, or even greater than 4.0 m²/g.

Particle sizes, and other particle size properties referred to in the present disclosure, are measured using a SEDIGRAPH 5100 instrument as supplied by Micromeritics Corporation. The size of a given particle is expressed in terms of the diameter of a sphere of equivalent diameter, which sediments through the suspension, i.e., an equivalent spherical diameter or esd.

All particle size data measured and reported herein, including in the examples, were taken in the above-described manner, with measurements made dispersed in water at the standard temperature under ambient air. All percentages and amounts expressed herein are by weight.

The mean particle size, or the d₅₀ value, is the value determined in this way of the particle esd at which there are 50% by weight of the particles, which have an esd less than that d₅₀ value.

Particle size distribution (psd) of particulate material can also be characterized by a “steepness factor.” Steepness is derived from the slope of a psd curve, where the particle diameter is plotted on the x-axis against a cumulative mass percentage of particles on the y-axis. A wide particle distribution has a low steepness value, whereas a narrow particle size distribution gives rise to a high steepness factor.

One embodiment provides a calcium carbonate that is ground to produce a larger particle size distribution compared to the feed calcium carbonate, i.e., a lower steepness factor. In one embodiment, the steepness factor is measured by a ratio of d₃₀/d₇₀×100, i.e., particle size at a cumulative mass of less than 30% of the particles, to particle size at a cumulative mass of less than 70% of the particles, as determined by Sedigraph 5100.

In one embodiment, the d₃₀/d₇₀×100 value is less than about 30, such as a d₃₀/d₇₀×100 value less than about 25, less than about 20, or less than about 18.

Other embodiments disclosed herein relate to a method of grinding calcium carbonate. In one embodiment, the ground calcium carbonate is prepared by attrition grinding. “Attrition grinding” as used herein refers to a process of wearing down particle surfaces resulting from grinding and shearing stress between the moving grinding particles. Attrition can be accomplished by rubbing particles together under pressure, such as by a gas flow.

In one embodiment, the attrition grinding is performed autogenously, where only the calcium carbonate particles are ground only by other calcium carbonate particles.

In another embodiment, the calcium carbonate is ground by the addition of an attrition grinding media other than calcium carbonate. Such additional grinding media can include ceramic particles (e.g., silica, alumina, zirconia, and aluminum silicate), plastic particles, or rubber particles.

In one embodiment, the calcium carbonate is ground in a mill. Exemplary mills include those described in U.S. Pat. Nos. 5,238,193 and 6,634,224, the disclosures of which are incorporated herein by reference. As described in these patents, the mill may comprise a grinding chamber, a conduit for introducing the calcium carbonate into the grinding chamber, and an impeller that rotates in the grinding chamber thereby agitating the calcium carbonate.

Gas can be introduced through a perforated base centrally located at the bottom of the grinding chamber, resulting in an upward flow of gas through the calcium carbonate. The perforated base, however, prevents the gas from passing through the central region of the grinding chamber, causing the gas to travel preferentially along the grinding chamber wall. When the calcium carbonate is rotated in the grinding chamber, a vortex can form resulting in a greater height of the calcium carbonate along the walls of the chamber compared to the central region.

In one embodiment, a horizontal top (baffle) plate having a central opening is positioned in the grinding chamber above the perforated base at a height to contain the bulk of the bed of calcium carbonate. The height above the perforated base is typically not greater than one half of the transverse width of the grinding chamber. The horizontal top plate can compress the bed of calcium carbonate particles along the walls of the chamber. This compression can reduce the mean spacing between the particles, allowing more frequent collision between the particles, and potentially, improving the grinding efficiency.

In another embodiment, the flow rate of the gas passing through the grinding chamber can be adjusted. In one embodiment, gas throughput ranges form about 10,000 m³/h to about 25,000 m³/h, such as a gas throughput of about 17,000 m³/h.

In one embodiment, the calcium carbonate is dry ground, where the atmosphere in the mill is ambient air.

In one embodiment, the impeller rotates in the grinding chamber at a peripheral speed ranging from about 5 m·s⁻¹ to about 20 m·s⁻¹, such as a peripheral speed ranging from about 8 m·s⁻¹ to about 11 m·s⁻¹.

In one embodiment, the feed calcium carbonate (prior to milling) can comprise calcium carbonate sources chosen from calcite, limestone, chalk, marble, dolomite, etc. Ground calcium carbonate particles can be prepared by any known method, such as by conventional grinding techniques discussed above and optionally coupled with classifying techniques, e.g., jaw crushing followed by roller milling or hammer milling and air classifying.

In one embodiment, the calcium carbonate is added as a dry feed. In another embodiment, a small amount of water, such as for example about 100 ppm to about 1000 ppm, such as for example at least about 200 ppm, may be added to the calcium carbonate prior to grinding in order to reduce heating of the calcium carbonate during the grinding process. In another embodiment, the water added can range from about 0% to about 10% by weight relative to the total weight of the feed, such as an amount ranging from about 100 ppm to about 10% by weight relative to the total weight of the feed.

In one embodiment, a grinding aid is added to the calcium carbonate. Exemplary grinding aids include, for example, triethanolamine, isopropyl alcohol and/or propylene glycol. For example, in one embodiment, triethanolamine may be added in an amount ranging from about 100 ppm to about 1000 ppm. In another embodiment, propylene glycol may be added in an amount ranging from about 100 ppm to about 1000 ppm, such as for example at least about 200 ppm.

In one embodiment, the dry ground calcium carbonate is further subjected to an air sifter. The air sifter can function to classify the ground calcium carbonate and remove a portion of residual particles greater than 20 μm.

In one embodiment, the calcium carbonate is surface treated with a treating agent such as those agents chosen from organic compounds, organic solvents, and polymers. The treating agent can be chosen from any dispersant commonly used in the art. For example, the treating agent may be chosen from fatty acids having at least 10, such as for example about 12, carbon atoms, and amines and quaternary ammonium compounds having at least one C₁₀₋₂₄ alkyl group. Exemplary dispersants include polyacrylates. In one embodiment, the treating agent is added after grinding in a manner known in the art.

In one embodiment, a product containing the ground calcium carbonate disclosed herein is free of dispersant, such as a polyacrylate. In another embodiment, the dispersant may be present in the product in an amount of up to about 5000 ppm.

In one embodiment, the ground calcium carbonate product is not substantially aggregated, e.g., most of the calcium carbonate particles exist as individual particles. For example, it is possible that at least about 90% and even at least 95% by weight of the calcium carbonate is non-aggregated.

Another embodiment of the present disclosure provides viscous nonaqueous suspensions comprising the ground calcium carbonate disclosed herein. In one embodiment, the nonaqueous suspension may have a solids content of at least about 50% by weight relative to the total weight of the suspension. In another embodiment, the nonaqueous suspension may have a solids content of at least about 65%, such as a solids content of at least about 70%, at least about 75%, or even at least about 80% by weight relative to the total weight of the suspension.

Another embodiment provides aqueous suspensions having a low viscosity. In one embodiment, the low viscosity is indicated by comparison to a noninventive analogous aqueous suspension having a calcium carbonate that does not have a d₅₀ of at least about 1.0 μm and a BET surface area of at least about 5.0 m²/g, or does not have a d₅₀ of at least about 2.3 μm and a BET surface area of at least about 4.0 m²/g. For example, the noninventive aqueous suspension can have a viscosity of at least about 1.5 times, at least about 2.0 times, at least about 2.5 times, or at least about 3.0 times the viscosity of the inventive aqueous suspension, as measured by a Brookfield Viscometer, for example where both suspensions were prepared in dioctylphthalate at a similar solids concentration.

In one embodiment, the inventive aqueous suspension has a solids content of at least about 70%, such as a solids content of at least about 75%, such as a solids content of at least about 80%.

The ground calcium carbonate product may be suitable for use in a variety of non-aqueous based products, such as paints, architectural coatings, industrial coatings, adhesives, caulks, and sealants, e.g., polysulphide sealing compositions. The calcium carbonate can be also used as a filler in rubber or plastics compositions. The inventive calcium carbonate can be beneficial in non-aqueous based applications requiring a relatively high viscosity, and may allow a reduction in the amount of thickener needed to produce a product having a desired viscosity. For example, when using the inventive calcium carbonate as a filler, products such as adhesives or caulks may be prepared using reduced levels of thickener than would otherwise be required. Similarly, sheet molding compositions may be prepared having an advantageous higher viscosity by using the inventive calcium carbonate.

The ground calcium carbonate can optionally include at least one organic or petroleum based resin, such as those conventionally used in the art.

Exemplary classes of resins include thermoplastic resins, fluorine resins, silicones, polyurethanes, polysulfides, modified silicones such as silylated polyurethanes (SPUR) and MS polymers (modified silicone polymers), and solvent-borne coatings including liquid resins (e.g., polyesters, alkyds, vinyls, epoxies, silicones, and polyurethanes).

Exemplary resins that can be used also include acrylonitrile-butadiene-styrene (ABS) resins, polyethylene terephthalate, polycarbonate, polyolefin resins such as polyethylene, polypropylene, ethylene-propylene copolymers, copolymers of ethylene or propylene with other monomers, polystyrene resins, acrylic resins, methacrylic resins, vinyl chloride resins, vinylidene chloride resins, polyamide resins, polyether resins, vinyl acetate resins, polyvinylalcohol resins, phenol resins, urea resins, melamine resins, epoxy resins, polyurethane resins, and polyimide resins. These resins may be used solely or in combination of two or more.

Exemplary resins for paints include solvent-type resins such as alkyd resins, acrylic resins, vinyl acetate resins, urethane resins, silicone resins, fluoro resins, styrene resins, melamine resins, and epoxy resins. For aqueous paints, general emulsion resins for paints can be used, such as alkyd resins, acrylic resins, latex resins, vinyl acetate resins, urethane resins, silicone resins, fluoro resins, styrene resins, melamine resins, and epoxy resins. General water-soluble resins for paint can include alkyd resins, amine resins, styrene-allyl alcohol resins, amino alkyd resins, and polybutadiene resins. Dispersion resins for paint can include blends of emulsion resins and water-soluble resins. Dispersion resins can include bridged water-soluble resins as an emulsifying agent and acrylhydrosols. These resins may be used solely or in combination of two or more.

Exemplary resins for plastics, such as plastisols, include polyvinyl-chloridesols, acrylhydrosols, water-soluble acrylsols, urethansols, and mixtures thereof.

Exemplary resins for sealants include polyurethane resins, polysulfide resins, silicone resins, modified silicone resins, polyisobutylene resins, epoxy resins, and polyester resins. These resins may be used solely or in combination of two or more.

Exemplary resins for adhesives include urea resins, phenol resins, epoxy resins, silicone resins, acrylic resins, polyurethane resins, and polyester resins. These resins may be used solely or as blends combining two or more different types of resins.

The blending ratio of the surface-treated calcium carbonate according to the present invention with these resins is not particularly limited, and can be appropriately determined in accordance with the desired physical properties. In one embodiment, the blending ratio is 1 to 100 parts by weight of the surface-treated calcium carbonate, relative to 100 parts by weight of resin.

At least one additive may be added as necessary, as known by one of ordinary skill in the art, such as those additives chosen from coloring agents and stabilizing agents. For adjusting the viscosity and other physical properties, the resin composition of the present disclosure may be added with, (besides the calcium carbonate described herein) fillers such as colloidal calcium carbonate, ground calcium carbonate, colloidal silica, talc, kaolin, zeolite, resin balloon and glass balloon; plasticizers such as dioctyl phthalate and dibutyl phthalate; solvents exemplified by petroleum solvents such as toluene and xylene, ketones such as acetone and methylethylketone, and ether esters such as cellosolve acetate. Various other additives and coloring agents such as silicone oil, fatty acid ester modified silicone oil and solvents (coalescing solvents, alcohols, aldehydes, hydrocarbons, ethers, esters, chlorinated solvents), plasticizers (used in plastisols) including phthalates (e.g., diisooctyl phthalate), adipates, phosphates, and sebacates. Other solvents used in adhesive and sealants can include hydrocarbons, alcohols, esters, ethers.

The ground calcium carbonate product may also be suitable for use in a variety of aqueous based products, such as aqueous based paints, coatings, adhesives, and caulks. The calcium carbonate may also be useful as coating for paper compositions. For example, the relatively low viscosity of the inventive product in aqueous suspensions can advantageously reduce the viscosity when used in paper coating applications, allowing application of the paper coating at higher solids content than might otherwise be possible. Similarly, the relatively low viscosity allows the inclusion of higher concentrations of the inventive calcium carbonate in aqueous paints than might otherwise be possible.

When used in such products, it is understood that the composition may optionally comprise at least one additional mineral as a filler or pigment. The at least one additional mineral can be a mineral that is different from the filler, such as calcined kaolin, hydrous kaolin, talc, mica, dolomite, silica, zeolite, gypsum, satin white, titania, and calcium sulphate.

### EXAMPLES

Examples 1-6 illustrate an embodiment of a method for producing a high surface area of calcium carbonate and, and the resulting effects on viscosity for nonaqueous and aqueous suspensions comprising the high surface area calcium carbonate in comparison to conventional calcium carbonates having a substantially similar particle size, d₅₀.

### Example 1

This Example describes the result of grinding calcium carbonate by the methods disclosed herein.

The inventive compositions were prepared by autogenously, dry grinding commercially available calcium carbonate (“Commercial Compositions” 1 and 2) with a mill having an impeller and horizontal baffle plate, as described above. The grinding was performed with a gas throughput of 17,000 m³/h. Commercial Composition 1 was crude marble obtained from Sylacauga, Ala. that was dry ground to have a d₅₀ of 3 μm. Commercial Composition 2 was crude marble obtained from Sylacauga, Ala. that was dry ground to have a d₅₀ of 2.5 μm. Inventive Composition 1 was the product of dry grinding, as described above, followed by air sifting to remove residual particles greater than 1 microns. Inventive Composition 2 was subject to the same conditions as Inventive Composition 1 except the air sifter was run at a faster speed to yield a desired median particle size.

Table I, below, lists the particle size distribution and 50% psd values for commercially available products versus inventive compositions having a nominally similar median particle size d₅₀.

TABLE I
Particle Size Distribution Data

| SEDIGRAPH | Inventive | Commercial | Inventive | Commercial |
|---|---|---|---|---|
| 5100 | Comp. 1 | Comp. 1 | Comp. 2 | Comp. 2 |
| % < 20 μm | 98.8 | 98.7 | 98.9 | 99.3 |
| % < 15 μm | 98.4 | 98.0 | 98.5 | 99.2 |
| % < 10 μm | 94.3 | 93.7 | 95.5 | 97.5 |
| % < 5 μm | 73.9 | 70.5 | 78.5 | 81.6 |
| % < 2 μm | 41.1 | 37.2 | 45.9 | 42.6 |
| % < 1 μm | 23.4 | 19.6 | 26.8 | 20.5 |
| 50% PSD | 2.9 | 2.7 | 2.3 | 2.4 |

It can be seen from Table I that the median particle size distribution of the inventive compositions is comparable to that of the commercially available compositions. However, even though the median particle sizes are similar, the overall particle size distribution of the inventive and commercially available calcium carbonate do differ in that the inventive calcium carbonate has a higher percentage of very fine particles.

### Example 2

The BET surface areas of the ground calcium carbonate samples were measured. Additionally, the surface area was also assessed with flow micrometry

Inventive compositions and A-D were prepared by subjecting Commercial Composition 1a to a mill, as described in Example 1. Commercial Composition 1a was obtained in the same manner as Commercial Composition 1 from Example 1. Inventive Composition C is the same as Inventive Composition 1 in Table I, above. Inventive Composition A was not air sifted. Inventive Composition B was ground at a higher throughput with 200 ppm propylene glycol.

The surface area data for the inventive compositions is shown below in Table II. The surface area was assessed by BET surface area (N₂) values and uptake of stearic acid from hexane. To determine stearic acid uptake, ground calcium carbonate (approximately 0.5 g) was weighed into a glass vial. A 0.2% solution of stearic acid in hexane (8 ml) was added and the suspension was agitated intermittently during 1 h. The suspension was filtered (0.45 μm cellulose nitrate membrane) and the filter cake was washed with clean hexane (3×8 ml). The filter cake was recovered and allowed to air dry. The powder was then analyzed by thermal gravimetric analysis (TGA) under the following conditions: sample size 40-60 mg; heating rate 40° C. under a flow of N₂. The TGA instrument was a Perkin Elmer TGA7. The uptake of stearic acid was estimated by measuring the weight loss between 250 and 450° C.

All the inventive calcium carbonate samples of Table II and the commercially available samples have a d₅₀ of approximately 3 μm.

TABLE II
3 μm samples

| | Uptake of Stearic Acid from Hexane | BET |
|---|---|---|
| Sample | (weight %) | (m²/g) |
| Inventive Comp. A | 1.02 | 6.0/5.3³ |
| Inventive Comp. B | 1.01 | 5.4 |
| Inventive Comp. C | 0.93/0.93 | 4.8/5.0 |
| Inventive Comp. D | 0.88 | 5.0/4.5 |
| Commercial Comp. 1a | 0.61 | 2.8/3.2 |

From the data of Table II, it can be seen that at a given particle size, the Inventive Compositions A-D have a higher surface area than the conventional Commercially Available calcium carbonate compositions 1 and 2. Although Inventive Compositions A-D and the conventional Commercially Available samples all have a d₅₀ of approximately 3 μm, the Inventive Compositions A-D have a BET surface area of approximately twice that of the Commercially Available samples. The BET surface value of Inventive Compositions A-D would more typically be observed from calcium carbonate samples having a d₅₀ of 1 μm or smaller.

Inventive compositions E-G were prepared by grinding Commercial Composition 2 with a mill to a median particle size of approximately 2.5 microns in a manner corresponding to that of Inventive Compositions A-C, respectively (Inventive Composition G corresponds to Inventive Composition 2 of Table I, above). Table III, below, shows the surface area data.

TABLE III
2.5 μm samples

| | Uptake of Stearic Acid from Hexane | BET |
|---|---|---|
| Sample | (weight %) | (m²/g) |
| Inventive Comp. E | 1.16 | 6.6 |
| Inventive Comp. F | 1.08 | 6.0 |
| Inventive Comp. G | 1.11/1.13³ | 6.2/6.3³ |
| Commercial Comp. 2 | 0.65/0.64 | 2.9/3.2³ |

From the data of Table III, it can be seen that the surface area increases after grinding. Although Inventive Compositions E-G and the Commercial Composition 2 samples have a d₅₀ of approximately 2.5 μm, the Inventive Compositions E-G have a BET surface area of approximately twice that of Commercial Composition 2.

### Example 3

This Example describes methods for manipulating the particle size distribution by grinding via the inventive method.

FIGS. 1 and 2 are plots of cumulative mass percent (y-axis) versus equivalent spherical diameter (μm, x-axis) as determined by Sedigraph 5100. FIG. 1 shows the differing particle size distribution between commercially available 3 μm d₅₀ calcium carbonate and a calcium carbonate ground to a nominally similar median particle size using the inventive method. FIG. 2 shows the differing in particle size distribution between a commercially available 2.5 μm d₅₀ calcium carbonate and another calcium carbonate ground to a nominally similar median particle size using the inventive method. Both FIGS. 1 and 2 show a wider particle size distribution (lower steepness factor or d₃₀/d₇₀×100) for the inventive, dry ground products.

### Example 4

This Example describes the preparation of nonaqueous viscous suspensions of calcium carbonate. The viscosity of nonaqueous suspensions of Commercial Compositions 1 and 2 and Inventive Compositions 1 and 2 of Example 1 were compared.

Samples were mixed at 45.8 wt % in dioctylphthalate plasticizer with sodium polyacrylate (Dispex® 2695, Ciba) in a Hamilton Beach mixer. Measurements were made on a Brookfield DVII+ viscometer using spindle S06 at 5 rpm. The viscosity of the nonaqueous suspensions were measured with a Brookfield Viscometer, spindle S06 at 5 rpm.

Over time, it can be seen that Commercial Compositions 1 and 2 maintain a viscosity of approximately 63,500 and 104,000 cps, respectively, as measured after 5 minutes. In contrast, the viscosities of Inventive Compositions 1 and 2 are much higher at the same time point (126,000 and 180,000, respectively) despite having the same d₅₀ as the commercially available analogs.

### Example 5

This Example describes the preparation of aqueous, low viscosity suspensions of calcium carbonate.

The viscosity of aqueous suspensions having a 75% solids concentration of Commercial Compositions 1 and 2 and Inventive Compositions 1 and 2 of Example 1 were compared at different dosages (pounds dispersant/ton CaCO₃, dry basis) of sodium polyacrylate (Dispex® 2695, Ciba). The viscosity of the aqueous suspensions were measured with a Brookfield Viscometer, spindle S06 at spindle speeds of 10, 20, 50, and 100 rpm. The viscosity data is shown in Table IV below in cps.

TABLE IV

| | VISCOSITY | | | | VISCOSITY | | | |
|---|---|---|---|---|---|---|---|---|
| Sample | DAY 1 (rpm) | | | | DAY 7 (rpm) | | | |
| (dosage in #/t) | 10 | 20 | 50 | 100 | 10 | 20 | 50 | 100 |
| Comp 1 (5) | 1670 | 980 | 484 | 309 | 1708 | 980 | 490 | 310 |
| Comp 1 (10) | 2200 | 1270 | 624 | 396 | 1612 | 954 | 488 | 319 |
| Comp 1 (20) | 2690 | 1570 | 776 | 490 | 1610 | 968 | 512 | 347 |
| Inv 1 (5) | 72 | 70 | 91 | 128 | 60 | 66 | 86 | 126 |
| Inv 1 (10) | 196 | 164 | 146 | 173 | 128 | 120 | 123 | 164 |
| Inv 1 (20) | 480 | 360 | 260 | 250 | 430 | 334 | 264 | 263 |
| Comp 2 (5) | 1576 | 918 | 494 | 332 | 1624 | 954 | 496 | 330 |
| Comp 2 (10) | 1504 | 904 | 483 | 330 | 1520 | 900 | 476 | 324 |
| Comp 2 (20) | 1488 | 942 | 532 | 385 | 1172 | 768 | 447 | 332 |
| Inv 2 (5) | 72 | 72 | 94 | 132 | 552 | 448 | 340 | 314 |
| Inv 2 (10) | 196 | 162 | 154 | 176 | 152 | 142 | 146 | 187 |
| Inv 2 (20) | 524 | 404 | 307 | 277 | 420 | 340 | 266 | 263 |

It can be seen from Table IV that the viscosities of the Inventive Compositions are lower than that of the corresponding Comparative Compositions.

Table V below compares the viscosities of Inventive Composition 1 and Comparative Composition 1 (in cps) at varying solids contents and dosages (pounds dispersant/ton CaCO₃, dry basis).

The viscosity of the aqueous suspensions were measured with a Brookfield Viscometer, spindle S06 at spindle speeds of 10, 20, 50, and 100 rpm.

TABLE V

| Sample | VISCOSITY at | | | | VISCOSITY at | | | |
|---|---|---|---|---|---|---|---|---|
| (solids | DAY 1 (rpm) | | | | DAY 18 (rpm) | | | |
| %/#/t) | 10 | 20 | 50 | 100 | 10 | 20 | 50 | 100 |
| Comp 1 | 1724 | 1026 | 517 | 328 | 2860 | 1680 | 844 | 526 |
| (75/2.5) | | | | | | | | |
| Comp 1 | 2604 | 1480 | 725 | 560 | 3600 | 2080 | 1040 | 662 |
| (77.5/5) | | | | | | | | |
| Comp 1 | 2756 | 1550 | 760 | 588 | 2680 | 1545 | 806 | 512 |
| (77.7/10) | | | | | | | | |
| Comp 1 | 3610 | 2085 | 1044 | 667 | 3100 | 1885 | 1012 | 682 |
| (77.7/15) | | | | | | | | |
| Comp 1 | 5350 | 3070 | 1554 | 1000+ | 5330 | 3190 | 1706 | 1000+ |
| (80.4/10) | | | | | | | | |
| Inv 1 | 232 | 208 | 205 | 244 | 5770 | 3440 | 1770 | 1000+ |
| (75/2.5) | | | | | | | | |
| Inv 1 | 124 | 118 | 134 | 195 | 180 | 175 | 180 | 222 |
| (77.8/5) | | | | | | | | |
| Inv 1 | 124 | 116 | 132 | 186 | 170 | 170 | 176 | 214 |
| (77.6/10) | | | | | | | | |
| Inv 1 | 760 | 552 | 398 | 355 | 1140 | 815 | 554 | 498 |
| (77.6/15) | | | | | | | | |
| Inv 1 | 160 | 148 | 160 | 224 | | | | |
| (78.6/5) | | | | | | | | |
| Inv 1 | 220 | 198 | 196 | 252 | 560 | 510 | 450 | 476 |
| (80.1/5) | | | | | | | | |
| Inv 1 | 420 | 380 | 380 | 393 | | | | |
| (81.6/5) | | | | | | | | |
| Inv 1 | 1170 | 905 | 692 | 660 | 2540 | 1950 | 1480 | 1000+ |
| (81.7/10) | | | | | | | | |

Again it can be seen from Table V that the viscosities of the Inventive Compositions are lower than that of the corresponding Comparative Compositions. Such low viscosity suspensions are advantageous in aqueous based paints or paper compositions as they provide a higher calcium carbonate solids content in comparison to the commercially available compositions.

### Example 6

This Example describes the dry grinding of calcium carbonate having larger particle sizes.

Various calcium carbonate samples were subjected to a mill as described in Example 1. The particle size data (d50) and BET surface area are shown in Table VI below.

TABLE VI

| | | Sedigraph | BET Surface area sq |
|---|---|---|---|
| Sample No | Source | (d50, μm) | m/g |
| Inventive H | Sylacauga | 7.0 | 4.4 |
| Inventive I | Sylacauga | 8.0 | 4.6 |
| Inventive J | Sylacauga | 13.5 | 3.5 |
| Comparative A | Sylacauga | 6.8 | 2.1 |
| | ball mill | | |
| Comparative B | Sylacauga | 9.7 | 2.2 |
| | ball mill | | |
| Comparative C | Marble hill | 8.1 | 1.4 |
| | ball mill | | |
| Comparative D | Maryland | 7.4 | 1.7 |
| | ball mill | | |

It can be seen that the inventive compositions that were milled as described in Example 1 had higher BET surface areas compared to the ball milled samples.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-4. (canceled)

5: A composition comprising ground calcium carbonate having a d50 of at least about 2.3 μm and a BET surface area of at least about 4.0 m²/g.

6: The composition according to claim 5, wherein the ground calcium carbonate has a d50 of at least about 2.5 μm.

7: The composition according to claim 5, wherein the ground calcium carbonate has a d50 of at least about 3.0 μm.

8: The composition according to claim 5, wherein the ground calcium carbonate has a BET surface area of at least about 4.5 m²/g.

9: The composition according to claim 5, wherein the ground calcium carbonate has a BET surface area of at least about 5.0 m²/g.

10: The composition according to claim 5, wherein the ground calcium carbonate has a d30/d70×100 value of less than about 30.

11: The composition according to claim 5, wherein the ground calcium carbonate has a d30/d70×100 value of less than about 25.

12: The composition according to claim 5, wherein the ground calcium carbonate has a d30/d70×100 value of less than about 20.

13: The composition according to claim 5, wherein the ground calcium carbonate has a d30/d70×100 value of less than about 18.

14. (canceled)

15: A product comprising:
a resin; and
a ground calcium carbonate having a d50 of at least about 2.3 μm and a BET surface area of at least about 4.0 m²/g.

16-17. (canceled)

18: The product according to claim 15, which is an adhesive.

19: The product according to claim 15, which is a caulk.

20: The product according to claim 15, which is a sealant.

21: The product according to claim 15, further comprising at least one pigment chosen from calcined kaolin, hydrous kaolin, talc, mica, dolomite, silica, zeolite, gypsum, satin white, titania, and calcium sulphate.

22: A method of grinding calcium carbonate, comprising autogenously dry grinding a calcium carbonate feed to produce a ground calcium carbonate having a d50 of at least about 2.3 μm and a BET surface area of at least about 4.0 m²/g.

23-24. (canceled)

25: The method according to claim 22, further comprising subjecting the autogenously ground calcium carbonate to an air sifter.

26: The method according to claim 22, wherein water is present in the feed in an amount ranging from about 100 ppm to about 10% by weight relative to the total weight of the feed.

27. (canceled)

28: A composition comprising a nonaqueous suspension comprising a ground calcium carbonate having a d50 of at least about 2.3 μm and a BET surface area of at least about 4.0 m²/g, wherein the nonaqueous suspension has a solids content of at least about 50%.

29. (canceled)

30: The composition according to claim 28, wherein the nonaqueous suspension has a solids content of at least about 65%.

31: The composition according to claim 28, wherein the nonaqueous suspension has a solids content of at least about 70%.

32: The composition according to claim 28, wherein the nonaqueous suspension has a solids content of at least about 75%.

33: The composition according to claim 28, wherein the nonaqueous suspension has a solids content of at least about 80%.

34: The composition according to claim 28, further comprising a dispersant present in an amount of no more than about 25 pounds per ton of dry calcium carbonate.

35. (canceled)

36: A composition comprising an aqueous suspension comprising:
a ground calcium carbonate having a d50 of at least about 2.3 μm and a BET surface area of at least about 4.0 m²/g, wherein the aqueous suspension has a solids content of at least about 50%.

37. (canceled)

38: The composition according to claim 36, further comprising a dispersant present in an amount of no more than about 25 pounds per ton of dry calcium carbonate.

39: The composition according to claim 36, wherein the aqueous suspension has a solids content of at least about 65%.

40: The composition according to claim 36, wherein the aqueous suspension has a solids content of at least about 70%.

41: The composition according to claim 36, wherein the aqueous suspension has a solids content of at least about 75%.

42: The composition according to claim 36, wherein the aqueous suspension has a solids content of at least about 80%.
